(19) United States
(12) Patent Application Publication
(10) Pub. No.: US 2019/0110168 A1
(43) Pub. Date: Apr. 11, 2019

(54) COMMUNICATIONS SYSTEM FOR ESTABLISHING COMMUNICATIONS BETWEEN MOBILE DEVICE AND TELEPHONE NETWORK OR BROADBAND NETWORK

(71) Applicant: D2 Technologies Inc., Santa Barbara, CA (US)

(72) Inventor: David Y. Wong, Santa Barbara, CA (US)

(21) Appl. No.: 16/151,352

(22) Filed: Oct. 4, 2018

Related U.S. Application Data
(60) Provisional application No. 62/568,795, filed on Oct. 6, 2017.

(51) Int. Cl. H04W 4/16; H04M 7/00; H04M 3/436; H04M 3/533; H04L 29/06

(52) U.S. Cl. CPC H04W 4/16; H04M 7/0039; H04M 7/009; H04W 4/20; H04M 3/533; H04M 7/0042; H04L 65/1006; H04M 3/436

(57) ABSTRACT

A communications system includes an adapter, an internet access device and a mobile device. The adapter is linked to a telephone network or a broadband internet network and configured to transceive voice data via the telephone network or the broadband internet network, perform data conversion between the voice data and corresponding internet protocol packets, and transceive the internet protocol packets. The internet access device is linked to the adapter and configured to make the adapter access an internet network. The mobile device is linked to the internet access device via the internet network and configured to transceive the internet protocol packets via the internet network. Communications between the adapter and the mobile device may be therefore established.

### CROSS REFERENCE TO RELATED APPLICATIONS

This application claims priority to provisional Patent Application No. 62/568,795, filed Oct. 6, 2017, and incorporated herein by reference in its entirety.

### BACKGROUND OF THE INVENTION

### 1. Field of the Invention

The present application is related to a communications system, and more particularly, a communications system for establishing communications between a mobile device and a telephone network or a broadband network.

### 2. Description of the Prior Art

A landline telephone has been invented for more than a hundred years. Today most people have at least one landline telephone, for example, a fixed home phone line or a fixed office phone line. Even with the introduction of mobile phones, many people still keep their fixed-line service. However, a fixed-line service has one major drawback. It requires a user to be physically close to a phone set within a short distance such as a few feet. Cordless phones were introduced to solve this problem. However, a cordless phone has two major deficiencies as well. First, a cordless phone requires a user to keep a cordless handset fully charged. Second, service provided by a cordless phone is confined to a user's home or within line-of-sight radio reach. Even within a user's home, service provided by a cordless phone often suffers from interferences from neighboring cordless phones, Wi-Fi radio, and mobile phone radio with various frequencies. There are telco (telephone company) services such as call forwarding to solve part of the problem of “home limitation” mentioned above. However, those services incur additional cost and are not user friendly enough. In addition, those telco services often merely provide inbound call services from an external terminal to a user, but not outbound call services made by the user.

FIG. 1 depicts a system of a cordless handset according to prior art. As shown in FIG. 1, a base unit B1 is connected to a telephone network N1 used for providing a fixed-line service. At home or office, the base unit B1 is linked to a cordless handset H1 over unregulated radio band such as 900 MHz, or digital enhanced cordless telecommunications (DECT). The cordless handset H1 may serve as a wireless extension of the fixed-line. The main problem of the design like the cordless handset H1 is that it can merely work within a very short range with no radio interference or obstruction, as is required for such unregulated radio technology. If the cordless handset H1 is moved outside the range of the radio, or if a neighbor's cordless radio signal interferes with the communications, the cordless handset H1 may not work properly. What is also inconvenient is that it also requires that the user holds a fully charged single purpose cordless handset close by.

### SUMMARY OF THE INVENTION

An embodiment provides a communications system including an adapter, an internet access device and a mobile device. The adapter is linked to a telephone network and used to transceive analog voice data through the telephone network, perform data conversion between the analog voice data and corresponding internet protocol packets, and transceive the internet protocol packets. The internet access device is linked to the adaption module and used to make the adapter access an internet network. The mobile device is linked to the internet access device via the internet network and configured to transceive the internet protocol packets via the internet network.

Another embodiment provides a communications system including a customer premises equipment and a mobile device. The customer premises equipment is linked to a first internet network and used to transceive digital voice data through the first internet network and perform data conversion between the digital voice data and intermediary data. The mobile device is linked to the customer premises equipment via a second internet network and used to transceive internet protocol packets corresponding to the intermediary data to communicate with the customer premises equipment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a system of a cordless handset according to prior art.

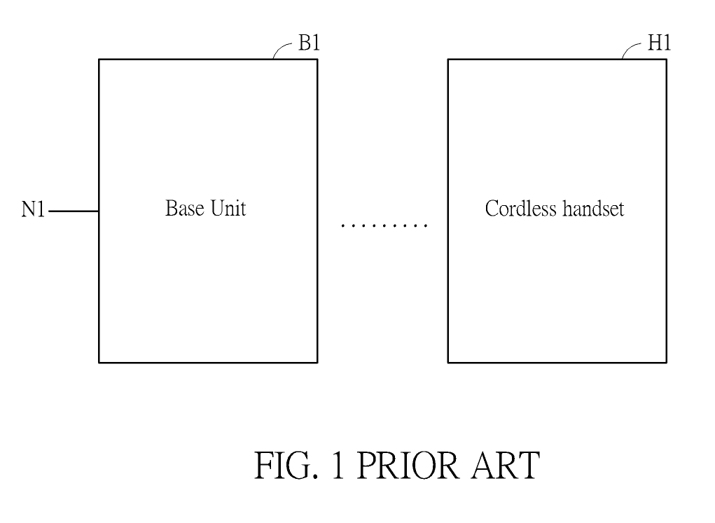

FIG. 2 illustrates a communications system according to an embodiment of the present application.

FIG. 3 illustrates further details related to the adapter and the mobile device according to an embodiment.

FIG. 4 illustrates that a PBX module is used to relay calls for a multi-line place according to an embodiment.

FIG. 5 illustrates that a VoIP CPE is integrated into the communications system according to an embodiment.

FIG. 6 illustrates a communications system including a hybrid CPE according to an embodiment.

FIG. 7 illustrates a communications system of FIG. 6 with more details of the hybrid CPE of FIG. 6 and the mobile device of FIG. 2.

FIG. 8 illustrates a call flow diagram corresponding to the structure of FIG. 7.

FIG. 9 illustrates a voice mail server module is added to the communications system of FIG. 2 according to an embodiment.

FIG. 10 illustrates a spam call server module is added to the communications system of FIG. 9 according to an embodiment.

### DETAILED DESCRIPTION

The present application may propose systems and techniques according to embodiments to solve the foresaid problem of lacking mobility in an easier and more cost-effective way. Global mobility may be provided without requiring the subscription of additional services from telecommunication operators.

Several consumer technology trends enable a far better solution to “cordless handsets”: 1. Most subscribers of fixed-line phone service now also have mobile service or Wi-Fi service inside their homes. 2. A vast majority of mobile users now have a smart phone and they keep their smart phones close by almost all the time because of a multitude of applications users are engaged in day and night such as short message service (SMS), chat service, media service, news service, email service, games, etc. 3. Wireless Internet access has been almost universally available around the developed world via mobile or Wi-Fi networks. Given the new technology and consumer realities, the present disclosure may offer a “ubiquitous connectivity” solution to a fixed-line phone service while it also eliminates the need to buy and carry a cordless handset.

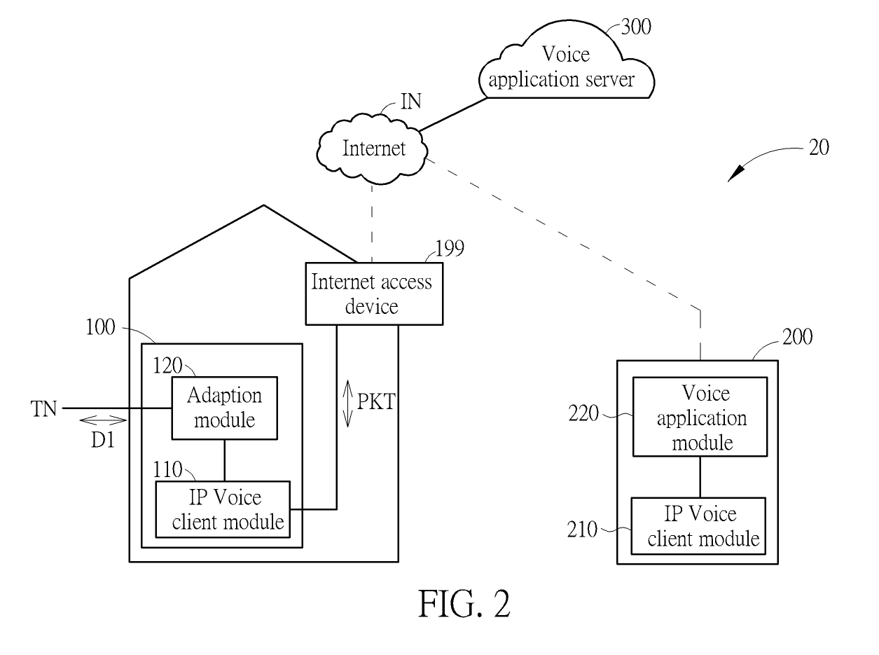

FIG. 2 depicts a communications system 20 according to an embodiment of the present application. The communications system 20 may include a mobility adapter 100, an internet access device 199 and a mobile device 200. The adapter 100 may be linked to a telephone network TN and used to transceive analog voice data D1 through the telephone network TN, perform data conversion between the analog voice data D1 and corresponding IP (internet protocol) packets PKT, and transceive the IP packets PKT. According to embodiments, the telephone network TN may be used for fixed telephone line service. For example, the telephone network TN may be (but not limited to) a public switched telephone network (PSTN). The telephone network TN may be regarded as a PSTN as an example below. The internet access device 199 may be linked to the adapter 100 and used to make the adapter 100 access an internet network IN. For example, the internet access device 199 may include (but not limited to) a router, an access point, a cable modem, a wireless network card or another device used for making the adapter 100 access the internet network IN. For example, when the internet access device 199 is a router, the internet access device 199 may route the IP packets PKT. The mobile device 200 may be linked to the internet access device 199 via the internet network IN and used to transceive the IP packets PKT.

According to embodiments, a voice application server 300 may be optionally linked to the internet network IN and used to process the IP packets PKT transceived between the adapter 100 and the mobile device 200. The analog voice data D1 maybe voice signals transceived via PSTN. The adapter 100 may be a hardware device designed to relay the analog voice data D1 to the voice application server 300 on the internet network IN. In a typical home environment, the adapter 100 may access the internet network IN via a home router (e.g. the internet access device 199) using Ethernet or Wi-Fi connection. The voice application server 300 may be an IP based soft switch which deals with the exchange of voice signals and streams. The mobile device 200 may be any portable device having wireless or cellular communications capability, on which application software, hardware and firmware can run. For example, the mobile device 200 may be a mobile smart phone, a tablet computer, a laptop computer or a desktop computer with a user access interface of an operation system such as Android or iOS. An IP voice client module 110 operating on the adapter 100 may register to the voice application server 300. In the mobile device 200, an IP voice client module 210 may be registered to the voice application server 300. According to an embodiment, voice data stream transmitted into the adapter 100 may be seamlessly transferred to the mobile device 200, and voice data stream transmitted into the mobile device 200 may be seamlessly transferred to the adapter 100.

When a call arrives the adapter 100 from the telephone network TN, a ringing signal may trigger an adaption module 120 of the adapter 100 to initiate an incoming call notification on a voice application module 220 of the mobile device 200 via the IP voice client module 110, the voice application server 300 and the IP voice client module 210 using a signaling protocol such as SIP (Session Initiation Protocol) or HTTP (Hypertext Transfer Protocol). The voice application module 220 may alert a user of the incoming call. When the user answers the call, the voice application module 220 may signal the adaption module 120 of the adapter 100 via the IP voice client module 210, the voice application server 300, and the IP voice client module 110. In response, the adaption module 120 may pick up a call from a line of the telephone network TN such as a PSTN line (or go off-hook) and perform data conversion between the analog voice data corresponding to inbound voice signals and the IP packets PKT. It may establish a Voice over IP (VoIP) call with the voice application module 220 using a protocol like SIP or HTTP. With this method, the mobile device 200 may receive a call arriving at the adapter 100 from a line of the telephone network TN, anytime and anywhere without geographical limitation, as long as the mobile device 200 is linked to the internet IN and the voice application server 300. Similarly, a user of the mobile device 200 may initiate a call to the telephone network TN using the voice application module 200 to establish a VoIP call with the adaption module 120 in the adapter 100. Each of the modules described above and below may be formed by software, hardware, and/or firmware.

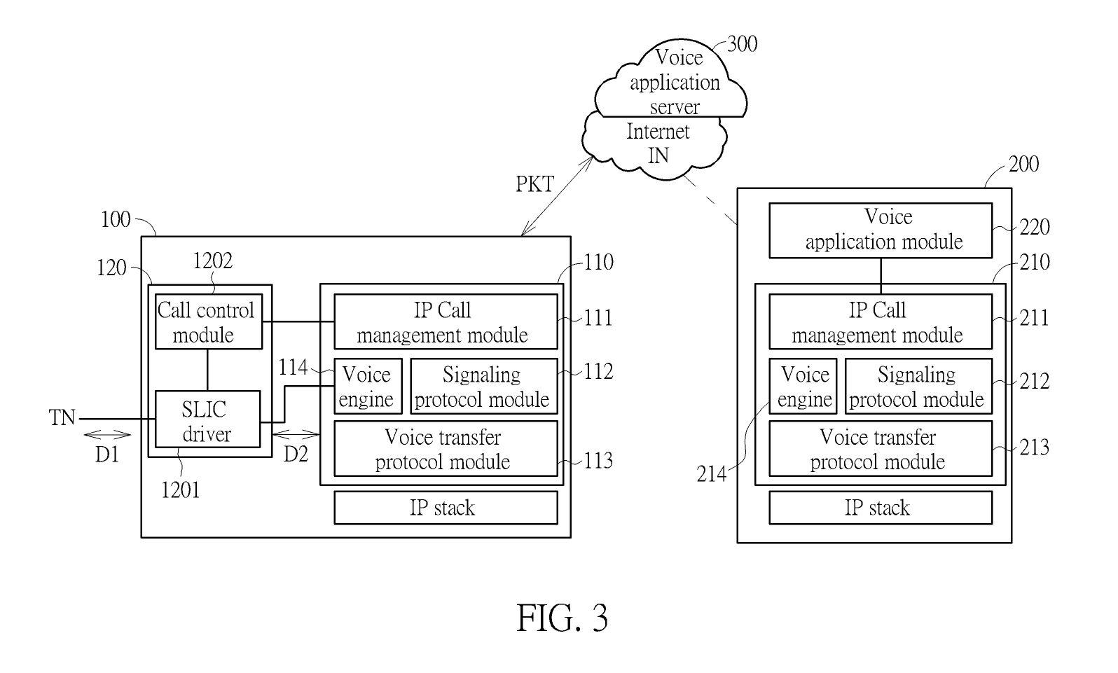

FIG. 3 depicts further details related to the adapter 100 and the mobile device 200 according to an embodiment. The adaption module 120 may include an SLIC (subscriber line interface circuit) driver 1201 and a call control module 1202 for processing PSTN signaling and voice data. The SLIC driver 1201 may handle a PSTN on/off hook interface, convert the inbound analog voice data D1 to digital data D2, and convert the outbound digital data D2 into analog voice data D1. The digital data D2 may be PCM (pulse code modulation) data. The IP voice client module 110 may include a voice engine 114, a signaling protocol module 112 and an IP call management module 111, where each of the voice engine 114, the signaling protocol module 112 and the IP call management module 111 may be formed with software and/or hardware. The voice engine 114 may process the voice of the digital data D2 to/from the SLIC driver 1201 and convert the incoming digital data D2 into the IP packets PKT and the outgoing IP packets PKT into the digital data D2. The voice engine 114 may perform other VoIP functions such as encoding, decoding, compression, decompression, jitter buffering, packet loss concealment, voice packet encapsulation, echo cancelation and so on to convert the digital (PCM) data D2 corresponding to the analog data D1 (from PSTN) into the IP packets PKT, and vice versa for IP packets PKT from the voice application server 300. The IP call management module 111 may be used to manage call processing and send a call notification to notify the mobile device 200 through the internet access device 199 when a call from PSTN is made. For example, when there is an incoming call from PSTN, the signaling protocol module 112 of the IP voice client 110 may notify the IP call management module 111, and the IP call management module 111 may in turn send a corresponding call notification to notify the mobile device 200 of the incoming call via the internet IN and the voice application server 300. Each of the adapter 100 and the mobile device 200 may include an IP stack for communications according to internet protocols.

The signaling protocol module 112 (of the adapter 100) and the signaling protocol module 212 (of the mobile device 200) are used to communicate with the voice application server 300 in a control plane of the internet IN. According to an embodiment, a protocol such as SIP, a telco standard for internet phone calls, or HTTP, typically used by OTT (Over the Top) applications, may be used for the signaling protocol. The adapter 100 may include a voice transfer protocol module 113, and the mobile device 200 may include a voice transfer protocol module 213. The voice transfer protocol modules 113 and 213 may be used to transport voice packets such as the IP packets PKT via a data plane of the internet IN. RTP (Real-Time Transfer Protocol) may be used according to an embodiment.

According to embodiments, a voice call from the telephone network such as PSTN may be extended to the mobile device 200 as long as the mobile device 200 is linked to the voice application server 300 via the internet IN at a user's home or outside a user's home. However, when the mobile device 200 is at home and is within a same local area network used by the adapter 100, the IP packets PKT carrying voice and transceived by the voice transfer protocol modules 113 and 213 may be exchanged locally without being sent out using a peer to peer (P2P) protocol and being relayed through the voice application server 300.

### Regarding PBX (Private Branch Exchange) Application:

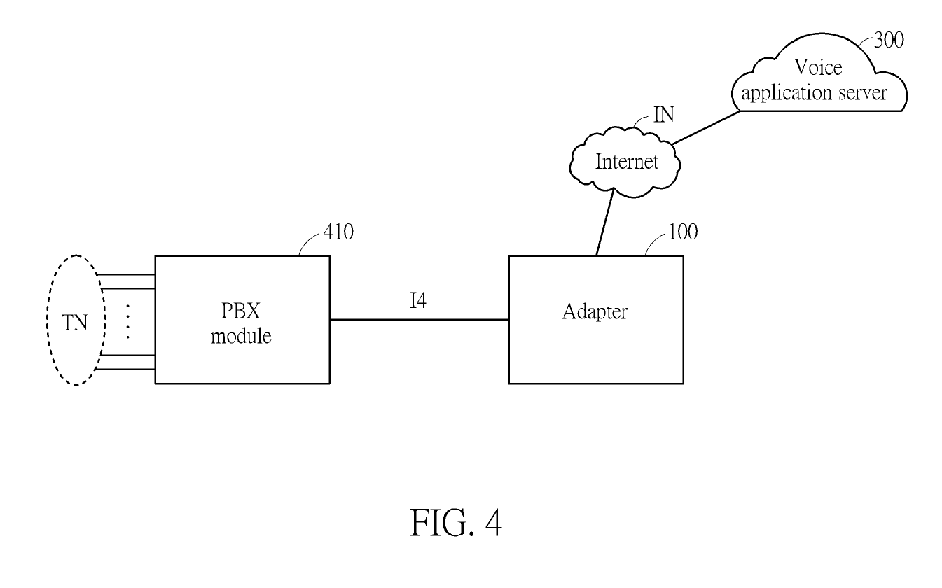

According to an embodiment, the present application may also be applied to a multi-line office in the same way as it is applied to a single line PSTN service. For such a multi-line office, there may be a PBX (private branch exchange) that distributes PSTN calls to a number of “extensions”, so the method described above may need to be operated using a PBX module as shown in FIG. 4. FIG. 4 illustrates a PBX module 410 is used to relay calls for a multi-line place (e.g. office, hotel, etc.) according to an embodiment. As shown in FIG. 4, the PBX module 410 may be optionally included in the system. The PBX module 410 may relay an incoming call to an extension, where the extension is corresponding to the voice application module 220 of the mobile device 200 and assigned to an intended PBX extension. The PBX module 410 may also make a call to the telephone network TN (e.g. PSTN) where the call is initiated by the voice application module 220 of the mobile device 200. In FIG. 4, an interface 14 between the PBX module 410 and the adapter 100 may be a digital interface and be proprietary for the PBX module 410. In another case, the interface 14 may be the same as an analog interface such as a standard PSTN interface.

### Regarding VoIP CPE (Customer Premise Equipment) Application:

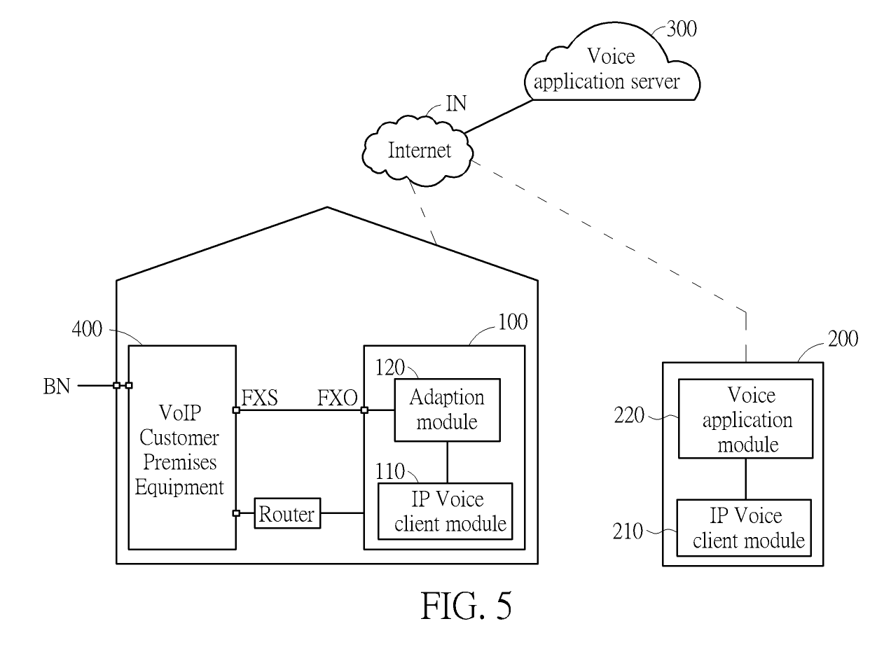

With the development of broadband digital subscriber loop, many ISPs (Internet service providers) have integrated voice service into CPE by using VoIP technology. FIG. 5 illustrates that a VoIP CPE 400 is integrated into the communications system according to an embodiment. The CPE 400 may have an interface for accessing an internet network BN, and the internet network BN may be a broadband internet network connection provided by an ISP. The interface of the CPE 400 may include an optical fiber interface, a cellular interface, a mobile interface and/or a DSL (digital subscriber line, also known as xDSL) interface. On the customer side, the CPE 400 may provide a legacy telephone port such as a FXS (foreign exchange station) port so that a legacy analog phone set may be used as if the legacy phone set is connecting to a PSTN. The mobility extension technique proposed in FIG. 2 may therefore be applied without any change, as depicted in FIG. 5.

### Regarding VoIP CPE Integration:

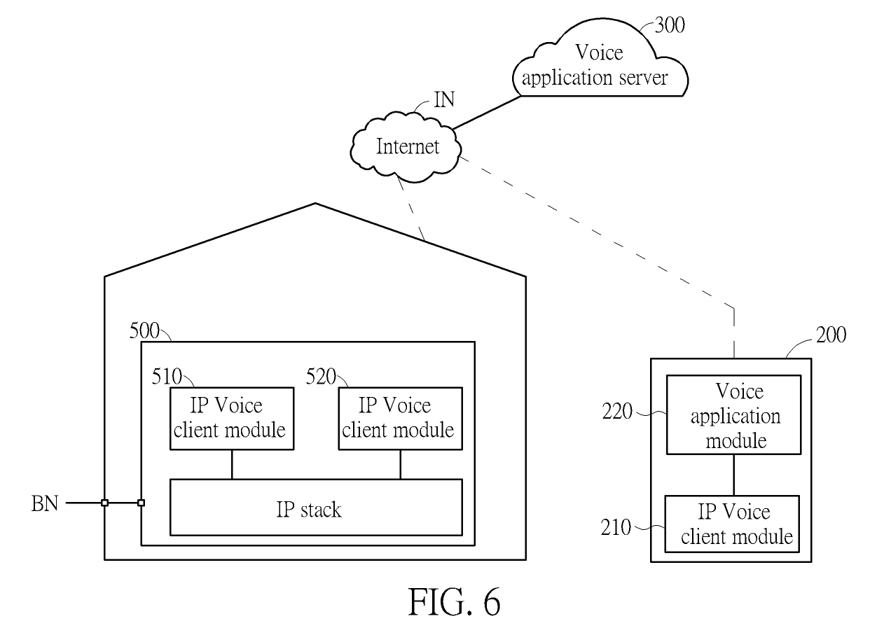

The structure depicted in FIG. 5 may be further optimized. It is possible to embed the function of the adapter 100 into the VoIP CPE 400 to have a hybrid CPE to minimize hardware cost and customer installation effort. FIG. 6 illustrates a communications system including a hybrid CPE 500 according to an embodiment. The functions of the CPE 400 of FIG. 5 and the adapter 100 of FIG. 5 may be combined into a single hardware that is the hybrid CPE 500 of FIG. 6. In the hybrid CPE 500, the function of software and hardware running on a broadband CPE device may correspond to an IP voice client module 510. As described above, the adapter 100 may also include the IP voice client module 110 for connecting to the voice application server 300. The foresaid IP voice client modules may be corresponding to the IP voice client modules 510 and 520 of the hybrid CPE 500. The IP voice client modules 510 and 520 may communicate with one another with a back-to-back user agent flow. The IP voice client modules 510 and 520 may have software stacks sitting back-to-back and collaborating to perform the mobility extension functionality in the hybrid CPE 500. This IP to IP connection may avoid the cost and quality degradation incurred by converting the VoIP packets into analog signal and converting the analog signal back into IP packets as required in FIG. 5.

When there is an incoming call from telco via the broadband internet BN, the IP voice client module 510 may notify the IP voice client module 520 to forward the incoming call signals (e.g. SIP INVITE) to the mobile device 200 via the internet IN and the voice application server 300. When the mobile device 200 accepts the call, a call acceptance signal (e.g. SIP 200 OK) may be sent and forwarded by the voice application server 300 to the IP voice client module 520 of the hybrid CPE 500. Then, the call acceptance signal may be further forwarded to the IP voice client module 510 and eventually sent back to connect the call. The mobile device 200 may also initiate a call by reversing the process described above.

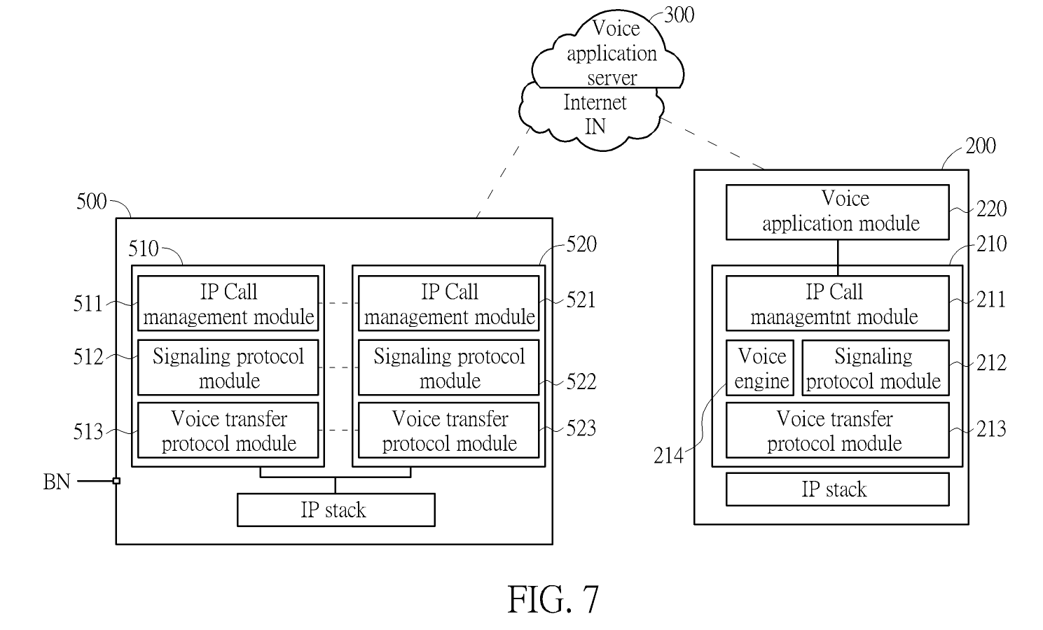

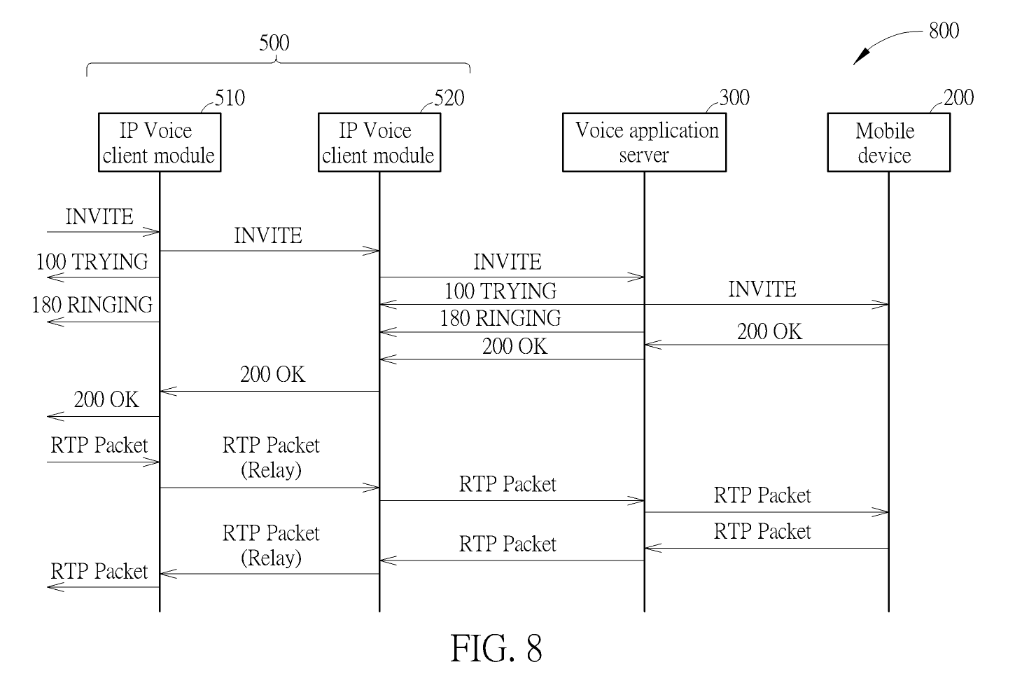

FIG. 7 illustrates a communications system of FIG. 6 with more details of the hybrid CPE 500 and the mobile device 200. FIG. 8 illustrates a call flow diagram 800 corresponding to the structure of FIG. 7. The call flow diagram 800 may correspond to the flow described above. When a call is established, voice packets may be sent from both directions. At the hybrid CPE 500, voice packets may be relayed and forwarded. Voice coding operation, voice decoding operation, analog-to-digital (A2D) conversion and digital-to-analog (D2A) conversion may not be required. As shown in FIG. 7, the IP voice client module 510 may include an IP call management module 511, a signaling protocol module 512 and a voice transfer protocol module 513. The IP voice client module 520 may include an IP call management module 521, a signaling protocol module 522 and a voice transfer protocol module 513. The functions of the modules of the IP voice client modules 510, 520 and the mobile device 200 may be similar to description above so it is not repeated.

An example of an incoming call flow using SIP as the voice signaling protocol and using RTP as voice transfer protocol may be as shown in FIG. 7 and FIG. 8. As shown in FIG. 8, a message “INVITE” may be sent from the broadband internet BN, a message “100 TRYING” may be a response, a message “200 OK” may be sent back, a message “RTP Packet” may be sent and relayed to the mobile device 200, and a message “RTP Packet” may be sent and relayed to the broadband internet BN linked to the IP voice client module 510. Hence, a call may be sent and answered by means of communications between the hybrid CPE 500 and the mobile device 200.

### Regarding Additional Cloud Based Applications for Fixed Telephone Lines:

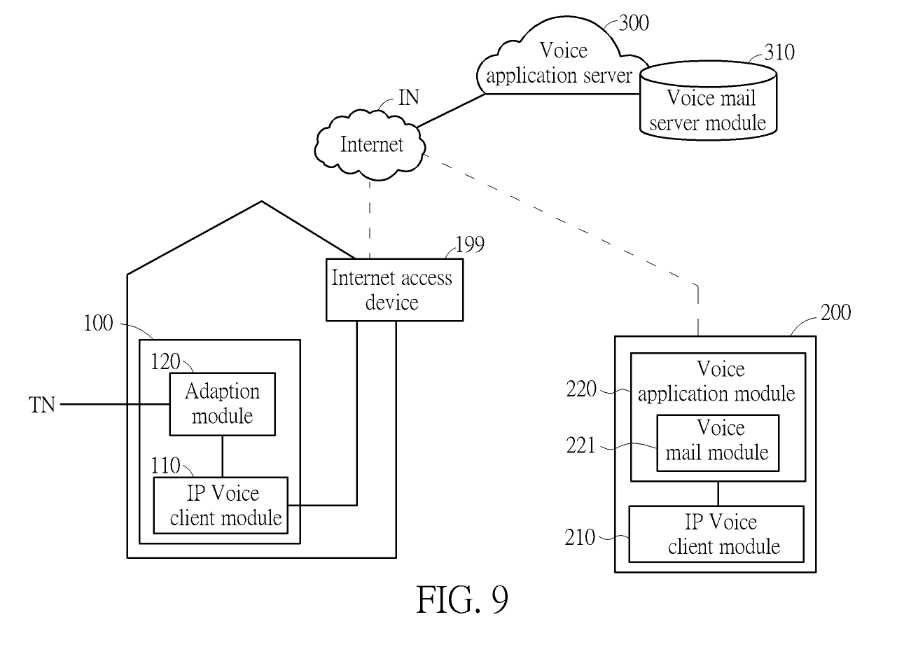

In addition to mobility extension to fixed line phone service, there may be other benefits through the introduction of the proposed technique in FIG. 2. One of them is the possibility of adding more functions by means of the voice application server 300. Since the calls may be transceived via the voice application server 300 on the cloud, it may be easy to add extra features such as voice mail service, fax termination service, voice to text translation service, call forwarding service, spam call filtering service, etc. FIG. 9 illustrates a voice mail server module 310 is added to the communications system of FIG. 2 according to an embodiment. FIG. 9 shows a feasible configuration where the voice mail server module 310 is added as one of the features of the voice application server 300. In the mobile device 200, a voice mail module 221 may be added as one of the features of the voice application module 220. The voice mail module 221 may transceive and store voice mails processed by the voice mail server module 310.

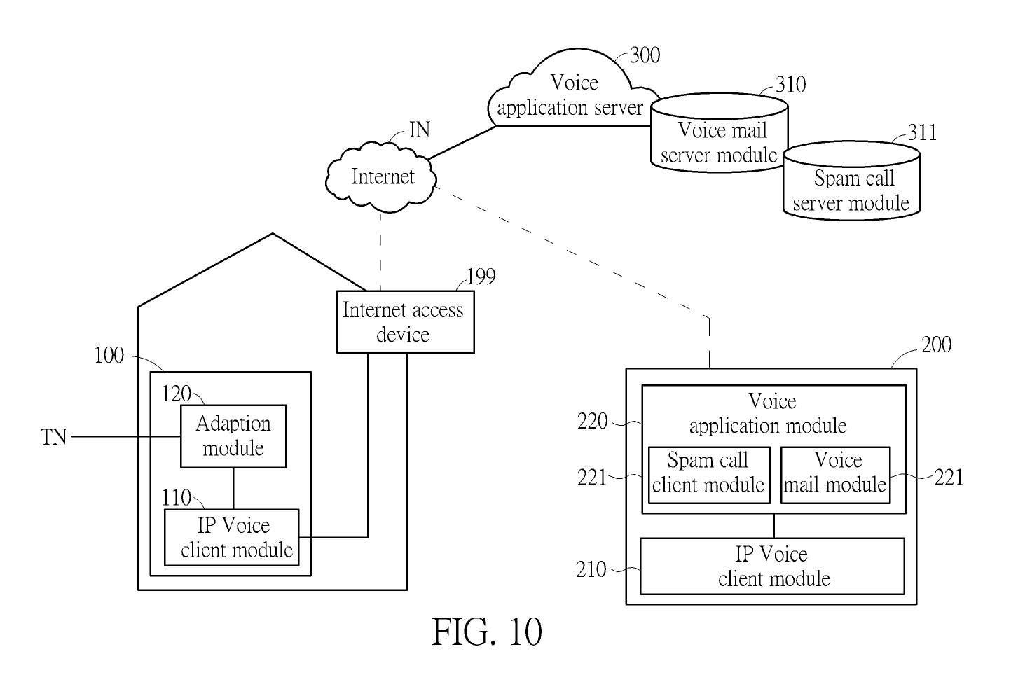

Likewise, addition features may be added by adding another functional server to the voice application server 300. FIG. 10 illustrates a spam call server module 311 is added to the communications system of FIG. 9 according to an embodiment. FIG. 10 shows another feasible configuration where the spam call server module 311 is added as one of the features of the voice application server 300. In the mobile device 200, a spam call client module 222 is added as one of the features of the voice application module 220. By means of the spam call server module 311 and the spam call client module 222, it may be possible to block spam calls. Likewise, other voice application services such voice-to-text translation service, language translation service, visual voice mail service and so on may be added by adding additional server modules to the voice application server 300 and corresponding functional modules to the voice application module 220.

In summary, by means of the foresaid solution disclosed according to embodiments, the deficiencies of conventional cordless phone may be overcome, and a user may use a mobile device such as a smart phone to answer or initial a call through a conventional telephone network or a broadband internet easily without suffering inconvenience. A plurality of additional services may also be addible.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communications system comprising:
an adapter linked to a telephone network and configured to transceive analog voice data through the telephone network, perform data conversion between the analog voice data and corresponding internet protocol packets, and transceive the internet protocol packets;
an internet access device linked to the adapter and configured to make the adapter access an internet network; and
a mobile device linked to the internet access device via the internet network and configured to transceive the internet protocol packets via the internet network.

2. The communications system of claim 1, wherein the adapter comprises:
an adaption module configured to perform data conversion between the analog voice data and corresponding digital data and control a first call from the telephone network; and
a first internet protocol voice client module linked to the adaption module and configured to perform data conversion between the digital data and the internet protocol packets, and notify the mobile device through the internet access device when the first call is made.

3. The communications system of claim 2, wherein:
the adaption module comprises:
a subscriber line interface circuit driver configured to perform data conversion between the analog voice data and the digital data; and
a call control module configured to control the first call; and
the first internet protocol voice client module comprises:
a first voice engine configured to perform data conversion between the digital data and the internet protocol packets;
a first signaling protocol module configured to inform a first internet protocol call management module when the first call is made; and
the first internet protocol call management module configured to send a first call notification to notify the mobile device through the internet access device when the first call is made.

4. The communications system of claim 2, wherein the mobile device comprises:
a second internet protocol voice client module configured to perform data conversion between the internet protocol packets and user voice signals and receive the first call notification; and
a voice application module linked to the second internet protocol voice client module and configured to alert a user when the second internet protocol voice client module receives the first call notification and notify the adaption module through the internet access device when the first call is answered.

5. The communications system of claim 4, wherein:
the second internet protocol voice client module comprises:
a second voice engine configured to perform data conversion between the internet protocol packets and the user voice signals;
a second internet protocol call management module configured to notify the voice application module when the first call notification is received; and
a second signaling protocol module configured to receive the first call notification from a first signaling protocol module of the adapter via the internet access device and notify the second internet protocol call management module accordingly.

6. The communications system of claim 1, further comprising:
a private branch exchange module linked between the telephone network and the adapter and configured to relay a first call from the telephone network to the mobile device through the adapter according to an extension number and relay a second call made on the mobile device to the telephone network through the adapter;
wherein the mobile device is corresponding to the extension number.

7. The communications system of claim 1, further comprising:
a voice application server linked to the internet network and configured to process the internet protocol packets transceived between the adapter and the mobile device.

8. The communications system of claim 7, wherein the voice application server processes the internet protocol packets to provide voice mail service, spam call filtering service, voice to text service and/or language translation service.

9. The communications system of claim 1, wherein the adapter comprises a first voice transfer protocol module, the mobile device comprises a second voice transfer protocol module, and the first voice transfer protocol module and the second voice transfer protocol module are configured to transceive the internet protocol packets between one another via a data plane of the internet network and the internet access device.

10. The communications system of claim 1, wherein the telephone network is a public switched telephone network.

11. The communications system of claim 1, wherein the internet access device comprises a router, an access point, a cable modem, a wireless network card or an device used for making the adapter access the internet network.

12. A communications system comprising:
a customer premises equipment linked to a first internet network and configured to transceive digital voice data through the first internet network and perform data conversion between the digital voice data and intermediary data; and
a mobile device linked to the customer premises equipment via a second internet network and configured to transceive internet protocol packets corresponding to the intermediary data to communicate with the customer premises equipment.

13. The communications system of claim 12, further comprising:
an adapter linked between the customer premises equipment and the second internet network and configured to perform data conversion between the intermediary data and the internet protocol packets.

14. The communications system of claim 13, wherein the customer premises equipment has a foreign exchange station port, and the adapter has a foreign exchange office port coupled to the foreign exchange station port.

15. The communications system of claim 12, wherein the customer premises equipment is further configured to perform data conversion between the digital voice data and the internet protocol packets, and the customer premises equipment comprises:
a first internet protocol voice client module configured to transceive a first notification corresponding to the digital voice data with the mobile device via the second internet network and relay the digital voice data to obtain the internet protocol packets; and
a second internet protocol voice client module configured to transceive a second notification and the internet protocol packets with the mobile device via the second internet network;
wherein the internet protocol packets correspond to the intermediary data, the customer premises equipment communicates with the mobile device according to the first notification and the second notification.

16. The communications system of claim 15, wherein the first internet protocol voice client module and the second internet protocol voice client module communicate with one another with a back-to-back user agent flow.

17. The communications system of claim 15, wherein a call flow among the first internet protocol voice client module, the second internet protocol voice client module, the second internet network and the mobile device is performed under a session initiation protocol and a real-time transport protocol without performing voice coding operation, voice decoding operation, analog-to-digital conversion and digital-to-analog conversion.

18. The communications system of claim 12, wherein the first internet network is provided by an internet service provider and the customer premises equipment is linked to the first internet network via an optical fiber interface, a cellular interface or a digital subscriber line interface.

19. The communications system of claim 12, further comprising:
a voice application server linked to the second internet network and configured to process the internet protocol packets transceived between the customer premises equipment and the mobile device.

20. The communications system of claim 19, wherein the voice application server process the internet protocol packets to provide voice mail service, spam call filtering service, voice to text service and/or language translation service.
